(19) United States
(12) Patent Application Publication
(10) Pub. No.: US 2004/0041087 A1
(43) Pub. Date: Mar. 4, 2004

(54) Multiple beam scanning device

(76) Inventors: Susumu Saito, Hitachinaka-shi (JP); Junshin Sakamoto, Hitachinaka-shi (JP); Katsuhiro Ono, Hitachinaka-shi (JP)

Correspondence Address: McGuireWoods LLP, Tysons Corner, Suite 1800, 1750 Tysons Boulevard, McLean, VA, 22102-4215, US

(21) Appl. No.: 10/647,507

(22) Filed: Aug. 26, 2003

(30) Foreign Application Priority Data
Aug. 27, 2002 (JP) P2002-246192

(51) Int. Cl. H01J 3/14

(52) U.S. Cl. 250/235

(57) ABSTRACT

A connection selection circuit is connected to laser elements of a first sub-array light source via a first circuit and also to laser elements of a second sub-array light source via a second circuit. The connection selection circuit initially connects a laser drive system to the laser elements of the first sub-array light source. When one or more of the laser elements of the first sub-array light source become defective, then the connection selection circuit connects the laser drive system to the laser elements of the second sub-array light source.

### BACKGROUND OF THE INVENTION

1. Field of the Invention

The present invention relates to a multiple beam scanning device for scanning a plurality of light beams in parallel across a light receiving member.

2. Related Art

Image output devices including laser printers and digital copy machines often use a multi-beam scan optical system that writes image information by simultaneously scanning a plurality of laser beams in parallel across a photosensitive member. The multi-beam scan optical system is capable of achieving a higher output speed and higher image dot density than single-beam systems without increasing rotational speed of a polygon mirror for scanning the laser beams or the speed at which the light intensity of the laser beams is modulated. The number of laser beams that such a system simultaneously scans in parallel is referred to as the scan beam number. To match demand for increasingly high image output speed and high dot density, the scan beam number has increased from two to four and then to five. See Applied Optics, Vol. 36, No. 25, September 1994. The scan beam number is expected to increase further in the future.

As disclosed in Japanese Patent-Application Publication No. HEI-2-160212, for example, semiconductor lasers are frequently used as the laser light source for emitting the laser beams because semiconductor lasers are easy to use and inexpensive. Also, each semiconductor laser can directly modulate the light intensity of the laser beam emitted from itself so that the plurality of laser beams can be modulated individually.

Conventionally, edge-emitting lasers (EELs) have been used as the semiconductor lasers. However, Japanese Patent-Application Publication No. HEI-5-294005 discloses also use of a vertical-cavity surface-emitting laser (VCSEL) as the semiconductor laser. VCSELs have the advantage in that 100 to 1,000 or more laser elements can be formed on the same substrate inexpensively and in a highly dense array so that images can be output at a high speed and high dot density by multi-beam scanning.

However, multi-beam scanning has a drawback in that quality of images can degrade or image information can be lost if even one of the laser light sources becomes defective, such as by emitting laser light with lower intensity than the others or by not emitting laser light at all. Accordingly, if any of the laser light sources breaks down, then the operation of the image output device must be stopped and the light source must be replaced with a properly operating one. Because image output operations must be stopped, this results in a loss in productivity. If the scan beam number, that is, the number of laser light sources, further increases in accordance with demand for higher speed and higher dot density, then the probability that any particular one of the laser light sources will break down will also increase. In this case, the resultant loss in productivity can no longer be ignored.

### SUMMARY OF THE INVENTION

It is an objective of the present invention to overcome the above-described problems and also to provide a multiple beam scanning device that reduces the duration of time that image output operations are stopped because a laser light source breaks down or otherwise becomes defective and that reduces the time until the multiple beam scanning device can be brought back to proper operating condition, and to provide an image output device that includes the multiple beam scanning device.

In order to attain the above and other objects, the present invention provides a multiple beam scanning device for scanning a plurality of light beams across a light receiving member, and an image output device including a light receiving member and the multiple beam scanning device. The multiple beam scanning device includes an array light source including a plurality of a sub-array light sources, each sub-array light source emitting a plurality of light beams with independently modulated light intensity, and an optical unit that converges the light beams emitted from any one of the sub-array light sources and simultaneously scans the light beams in parallel and with equidistant spacing across the light receiving member.

There is also provided a multiple beam scanning device for scanning a plurality of light beams across a light receiving member, and an image output device including a light receiving member and the multiple beam scanning device. The multiple beam scanning device includes an array light source including a plurality of a sub-array light sources, each sub-array light source emitting a plurality of light beams with independently modulated light intensity, a selection unit that selects one of the sub-array light sources, and a drive unit that drives the selected one of the sub-array light sources to emit the light beams. The selection unit connects the selected sub-array light source to the drive unit.

### BRIEF DESCRIPTION OF THE DRAWINGS

In the drawings:

FIG. 1 is a block diagram showing an image output device according to a first embodiment of the present invention; and

FIG. 2 is a block diagram showing an image output device according to a second embodiment of the present invention.

### DETAILED DESCRIPTION OF THE EMBODIMENTS

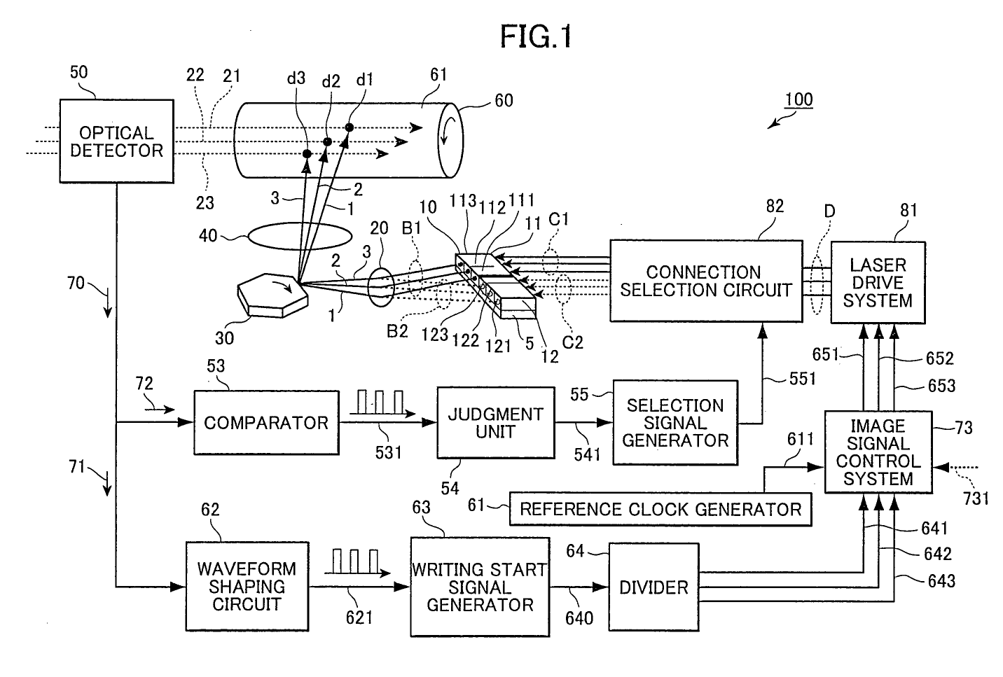

Next, an image output device 100 that includes a multiple beam scanning device according to a first embodiment of the present invention will be described with reference to FIG. 1.

As shown in FIG. 1, the image output device 100 includes an array light source 10, a first optical system 20, a rotating polygon mirror 30, a second optical system 40, an optical detector 50, and a light receiving member 60. The light receiving member 60 is rotated at a fixed speed in a sub-scanning direction indicated by an arrow in FIG. 1.

The array light source 10 includes a substrate 5, and two sub-array light sources 11, 12. The sub-array light sources 11, 12 are integrally formed together. The sub-array light source 11 includes three edge-emitting lasers 111, 112, and 113. The sub-array light source 12 includes three edge-emitting lasers 121, 122, and 123. The edge-emitting lasers 111, 112, 113, 121, 122, and 123 are aligned in a straight line on the substrate 5 and each is capable of emitting a laser beam with light intensity modulated independently from the other light beams. The three light beams from the sub-array light source 11 fall incident on the first optical system 20 as beam bundle B1. In the same way, the three light beams from the sub-array light source 12 fall incident on the first optical system 20 as beam bundle B2.

The first optical system 20 includes a collimator lens and a cylindrical lens and collects and collimates the beam bundle B1 (B2) from the array light source 10 and makes the beam bundle B1 (B2) image information writing laser beams 1, 2, 3. The rotating polygon mirror 30 simultaneously deflects and scans the light beams 1, 2, 3 on a surface of the light receiving member 60. The second optical system 40 includes a fθ lens which converges the scanned light beams 1, 2, 3 on the optical detector 50 and the light receiving member 60 as laser spots with a predetermined small diameter d₁, d₂, d₃, respectively. By the manner states above, the light beams 1, 2, 3 are scanned repeatedly by the rotating polygon mirror 30, in the direction (a main scanning direction) perpendicular to the moving direction of the light receiving member 60. On the light receiving member 60, the light beams with their spot diameter d₁, d₂, d₃ respectively are scanned in a main scanning direction, and form scan lines 21, 22, 23, successively. The scan lines 21, 22, 23 have equivalent neighboring spacing in the sub-scanning direction. The optical detector 50 is for detecting the light beams (scan beams) 1, 2, 3 and is disposed adjacent to the light receiving member 60 at a position separated from a writing region, where image information is written by the light beams 1, 2, 3.

As shown in FIG. 1, the image output device 100 also includes a reference clock generator 61, a waveform shaping circuit 62, a writing start signal generator 63, a divider 64, an image signal control system 73, a laser drive system 81, and a connection selection circuit 82. The laser drive system 81 is for driving each of the laser elements 111, 112, 113, 121, 122, 123. The laser drive system 81 includes an output circuit D connected to the connection selection circuit 82. The output of the connection selection circuit 82 is connected to the laser elements 111, 112, 113 of the sub-array light source 11 through a circuit C1 and to the laser elements 121, 122, 123 of the sub-array light source 12 through a circuit C2. Although the connection selection circuit 82 is capable of selecting either the circuit C1 or the circuit C2, initially the connection selection circuit 82 is set to select the circuit C1 so that the laser drive system 81 is initially connected to the sub-array light source 11.

Next, operations performed in the image output device 100 to write image information on the light receiving member 60 will be explained.

When the laser beams 1, 2, and 3 pass over the optical detector 50, the optical detector 50 generates a scan beam detection signal 70. The scan beam detection signal 70 is used both as a writing start signal 71 for starting operation to write image information and as a detection signal 72 for intensity of the light beams. Because the three laser beams 1, 2, and 3 are aligned at a slant with respect to the sub-scan direction, the laser beams 1, 2, and 3 pass by the optical detector 50 delayed one from the other by a predetermined time delay. Accordingly, the scan beam detection signal 70 has three pulses, which correspond to the three laser beams 1, 2, and 3. The amplitude of each beam detection signal indicates the intensity of the corresponding light beam 1, 2, and 3.

The waveform shaping circuit 62 shapes the writing start signal 71 into three consecutive pulse signals 621 and then send these pulses signals 621 to the writing start signal generator 63. The writing start signal generator 63 generates a writing start signal 640 based on the pulse signals 621. The divider 64 divides the writing start signal 640 into writing start signals corresponding to a number of scanning light beams and, in this case, outputs three writing start signals 641, 642, and 643 to the image signal control system 73. The writing start signals 641, 642, and 643 correspond to the laser elements 111, 112, 113 (121, 122, 124), respectively. The image signal control system 73 is also input with a clock signal 611 from the reference clock generator 61 and an image information signal 731 from an external source. The image signal control system 73 arranges the image information signal 731 into light intensity modulation signals 651, 652, 653 according to the scanning light beams, that is, the number of scan beams, of the light receiving member 60. Each light intensity modulation signal 651, 652, 653 includes a single scan line's worth of information in time sequence order for writing the corresponding one of the scan lines 21, 22, and 23. The light intensity modulation signals 651, 652, 653 are output to the laser drive system 81 in synchronization with the clock signal 611 and the writing start signals 641, 642, 643.

Because the laser drive system 81 is connected to the sub-array light source 11 through the circuit C1, the laser elements 111, 112, and 113 emit at total of three light beams for a single scanning. The light beams are intensity modulated based on the light intensity modulation signals 651, 652, and 653. The three light beams pass through the first optical system 20 as the beam bundle B1 and fall incident on the rotating polygon mirror 30 as the image information writing laser beams 1, 2, and 3. The rotating polygon mirror 30 reflects the laser beams 1, 2, and 3 simultaneously. The deflected laser beams 1, 2, and 3 are converged by the second optical system 40 into laser spots d₁, d₂, d₃ and form scan lines 21, 22, and 23 on the surface of the light receiving member 60. An electrostatic latent image is formed on the surface of the light receiving member 60 by repeating the above-described operations.

Quality of printed images can be degraded or print information can be lost due to problems with even one of the laser elements 111, 112, 113, such as intensity of one of the laser elements 111, 112, 113 dropping below a certain value or one of the laser elements 111, 112, 113 breaking down and not emitting light. When such a problem occurs, use of the sub-array light source 11 is stopped and switched to the sub-array light source 12. As a result, in a manner similar to the beam bundle B1 from the sub-array light source 11, the beam bundle B2 from the laser elements 121, 122, and 123 of the sub-array light source 12 scans across the light receiving member 60 via the first optical system 20, the rotating polygon mirror 30, and the second optical system 40 as scan lines 21, 22, and 23 to form an electrostatic latent image on the surface of the light receiving member 60.

Next, the switching mechanism for switching between the sub-array light source 11 and the sub-array light source 12 will be, described. The switching mechanism includes a comparator 53, a judgment unit 54, a selection signal generator 55, the optical detector 50, and the connection selection circuit 82.

The light intensity detection signal 72 from the optical detector 50 is sent to the comparator 53. The comparator 53 outputs an output signal 531 based on the light intensity of the light beams 1, 2, and 3, that is, based on the amplitude of the pulses in the light intensity detection signal 72. Described in more detail, the comparator 53 outputs a pulse when the amplitude of a pulse is within a predetermined range, but does not output a pulse when the amplitude of a pulse is outside the predetermined range. If the sub-array light source 11 is operating properly, then the amplitude all three pulses in the scan beam detection signal 70 will be within the predetermined range. Therefore, the resultant output signal 531 will have the normal waveform of three consecutive pulses as shown in FIG. 1. However, if the sub-array light source 11 is not operating properly because one or more of the laser elements 111, 112, 113 have broken down or for some other reason, then the amplitude of the corresponding pulse in the scan beam detection signal 70 will be outside the predetermined range. Therefore, the resultant output signal 531 will have one or more fewer pulses than the normal waveform.

The output signal 531 is input into the judgment unit 54. The judgment unit 54 judges whether or not the sub-array light source 11 is operating normally based on whether the output signal 531 includes three consecutive pulses. The judgment unit 54 outputs a judgment signal 541 only when the judgment unit 54 judges that the sub-array light source 11 is operating improperly. The judgment unit 54 outputs no judgment signal 541 when the sub-array light source 11 is operating normally. When the selection signal generator 55 receives the judgment signal 541, then the selection signal generator 55 generates and outputs a selection signal 551 to the connection selection circuit 82. As a result, the connection selection circuit 82 switches connection from the circuit C1 to the circuit C2. The output circuit D of the laser drive system 81, which was connected to the sub-array light source 11 through the circuit C1, is connected to the sub-array light source 12 through the circuit C2, thereby bringing the sub-array light source 12 into operation condition.

The first optical system 20 has a sufficiently large aperture to pick up the light bundles B1, B2 from the array light source 10. Six laser beams form laser spots with a uniform spot diameter at equidistant spacing on the surface of the light receiving member 60. Moreover, the multiple beam scanning optical system, which is mainly configured from the array light source 10, the first optical system 20, the rotating polygon mirror 30, and the second optical system 40, is designed to optimally prevent problems, such as scan line bowing, from occurring. The sub-array light sources 11, 12 are configured to both emit light beams of equivalent intensity and at an equivalent interspacing. Therefore, images written on the light receiving member 60 will have consistent quality regardless of which of the sub-array light sources 11, 12 is used.

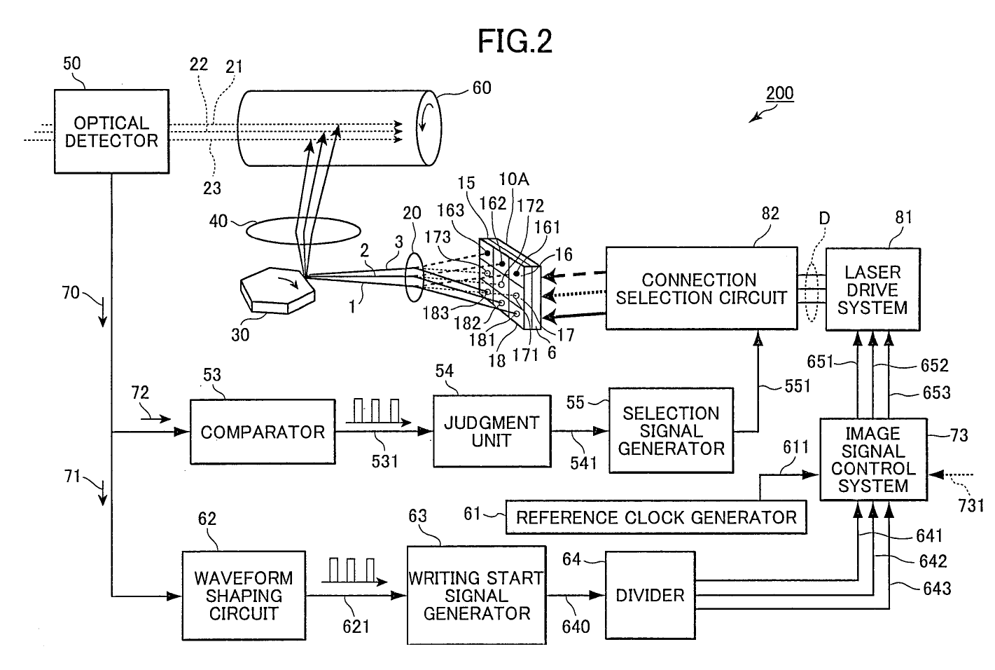

Next, an image output device 200 according to a second embodiment of the present invention will be described with reference to FIG. 2.

The image output device 200 has the same basic configuration as the image output device 100 shown in FIG. 1, with the exception that the image output device 200 uses an array light source 10A as its light source. The array light source 10A is a two-dimensional array light source formed from nine integral laser elements 15 in a three-by-three flat array. The laser elements 15 are grouped into three sub-array light sources 16, 17, and 18. The sub-array light source 16 is configured from laser elements 161, 162, and 163, the sub-array light source 17 is configured from laser elements 171, 172, and 173, and the sub-array light source 18 is configured from laser elements 181, 182, and 183.

Each of the sub-array light sources 16, 17, and 18 emits three laser beams that, in a manner similar to that of the first embodiment, scan across the light receiving member 60 via operation of the first optical system 20, the rotating polygon mirror 30, and the second optical system 40. The method of writing image information on the light receiving member 60 is also the same as for the first embodiment so detailed explanation will be omitted.

If one of the laser light sources 161, 162, 163 becomes defective during write operations using the sub-array light source 16, then the connection selection circuit 82 switches to the sub-array light source 17 on a judgment method similar to that described in the first embodiment. If one of the laser light sources 171, 172, 173 of the sub-array light source 17 becomes defective, then the connection selection circuit 82 switches to the sub-array light source 18 using a similar judgment process.

According to the above-described first and second embodiments, breakdown or other problems with the sub-array light source is detected based on the light intensity of each of the multiple beams, which is constantly detected during scanning operations. Therefore, the sub-array light source is constantly monitored, and problems with the sub-array light source can be promptly detected and electrical connection can be switched from the presently used array light source to another array light source.

Because operations can be quickly switched to use of a properly operating laser light source, the multiple beam scanning device can be easily returned to proper operation even if one of the laser elements becomes defective. There is no need to replace or repair the multiple beam scanning device or the entire image output device that uses the multiple beam scanning or to stop image output operations for long periods of time for repairs. High quality image output operations can be efficiently executed, and operation efficiency can be greatly increased. Problems that result from defective sub-array light sources, such as reduction in output image quality, can be prevented.

The image output device can be operated stably for long periods of time even if there is no future improvement in reliability of the individual laser elements from present levels. Accordingly, running costs can be greatly reduced compared to the convention configuration where the entire image output device needed to be replaced each time one of the laser elements became defective.

Because the operation of switching the sub-array light source is performed electrically, the switching is performed easily.

Because the plurality of sub-array light sources are integrally formed, the array light sources can be easily and precisely configured. Because each sub-array light source emits the same number of scan beams, the same image output controls can be used regardless of which sub array is presently being used. Because all of the sub-array light sources produce the same image quality, image quality can be maintained whether sub-array light sources are switched or not.

While the invention has been described in detail with reference to the specific embodiments thereof, it would be apparent to those skilled in the art that various changes and modifications may be made therein without departing from the spirit of the invention.

For example, the embodiments describe the present invention applied to a multiple beam scanning device that includes three laser beams in each sub-array light source. However, according to the present invention, any optional number of laser beams can be used. For example, four or more laser elements may be needed in each sub array, depending on the specifications of the image output device. Note that the greater the number of laser elements, the greater the probability that output of any one of the laser elements will fluctuate or degrade. Therefore, the present invention is particularly effective when used in an image output device that includes array light source with a large number of laser elements.

The embodiments describe array light sources configured from laser elements that are integrally formed on the same substrate. However, sub-array light sources formed on separate substrates can be either integrated together or arranged separately and used with a common scanning optics system.

Vertical-cavity surface-emitting lasers (VCSEL) could be used as the laser elements rather than edge-emitting lasers (EELs).

What is claimed is:

1. A multiple beam scanning device for scanning a plurality of light beams across a light receiving member, the multiple beam scanning device comprising:
an array light source including a plurality of a sub-array light sources, each sub-array light source emitting a plurality of light beams with independently modulated light intensity; and
an optical unit that converges the light beams emitted from any one of the sub-array light sources and simultaneously scans the light beams in parallel and with equidistant spacing across the light receiving member.

2. The multiple beam scanning device as claimed in claim 1, further comprising:
a detection unit that detects when a presently-used sub-array light source of the plurality of sub-array light sources is defective, the presently-used sub-array light source presently emitting the plurality of light beams to be scanned by the optical unit; and
a switching unit that switches a sub-array light source to use from the presently-used sub-array light source to a different one of the plurality of sub-array light sources when the detection unit detects that the presently-used sub-array light source is defective.

3. The multiple beam scanning device as claimed in claim 2, wherein the detection unit includes a light detection unit that detects light intensity of each light beam emitted from the presently-used sub-array light source, the detection unit detecting that the presently-used sub-array light source is defective when the light detection unit detects that the light intensity of at least one of the plurality of light beams emitted from the presently-used sub-array light source is outside a predetermined range.

4. The multiple beam scanning device as claimed in claim 1, wherein the array light source further includes a common base for all of the sub-array light sources, each of the sub-array light sources including the same number of semi-conductor lasers formed integrally on the common base.

5. The multiple beam scanning device as claimed in claim 4, wherein the semi-conductor lasers of each sub-array light source are arranged in a first direction, and the sub-array light sources are arranged in a second direction perpendicular to the first direction.

6. A multiple beam scanning device for scanning a plurality of light beams across a light receiving member, the multiple beam scanning device comprising:
an array light source including a plurality of a sub-array light sources, each sub-array light source emitting a plurality of light beams with independently modulated light intensity;
a selection unit that selects one of the sub-array light sources; and
a drive unit that drives the selected one of the sub-array light sources to emit the light beams, wherein the selection unit connects the selected sub-array light source to the drive unit.

7. The multiple beam scanning device as claimed in claim 6, further comprising a detection unit that detects when the selected sub-array light source is defective, wherein the selection unit selects a different one of the sub-array light sources when the detection unit detects that the currently selected sub-array light source is defective.

8. The multiple beam scanning device as claimed in claim 6, wherein the array light source further includes a common base for all of the sub-array light sources, each of the sub-array light sources including the same number of semi-conductor lasers formed integrally on the common base.

9. An image output device comprising:
a light receiving member; and
the multiple beam scanning device of claim 1.

10. The image output device as claimed in claim 9, wherein the multiple beam scanning device further includes:
a detection unit that detects when a presently-used sub-array light source of the plurality of sub-array light sources is defective, the presently-used sub-array light source presently emitting the plurality of light beams to be scanned by the optical unit; and
a switching unit that switches a sub-array light source to use from the presently-used sub-array light source to a different one of the plurality of sub-array light sources when the detection unit detects that the presently-used sub-array light source is defective.

11. The image output device as claimed in claim 10, wherein the detection unit includes a light detection unit that detects light intensity of each light beam emitted from the presently-used sub-array light source, the detection unit detecting that the presently-used sub-array light source is defective when the light detection unit detects that light intensity of at least one of the plurality of light beams emitted from the presently-used sub-array light source is outside a predetermined range.

12. The image output device as claimed in claim 9, wherein the array light source further includes a common base for all of the sub-array light sources, each of the sub-array light sources including the same number of semiconductor lasers formed integrally on the common base.

13. An image output device comprising:
a light receiving member; and
the multiple beam scanning device of claim 6.

14. The image output device as claimed in claim 13, wherein the multiple beam scanning device further includes a detection unit that detects when the selected sub-array light source is defective, and the selection unit selects a different one of the sub-array light sources when the detection unit detects that the currently selected sub-array light source is defective.
